(19) United States
(12) Patent Application Publication
(10) Pub. No.: US 2013/0125414 A1
(43) Pub. Date: May 23, 2013

(54) BLOW DRYING MECHANISM FOR WORKPIECES

(71) Applicant: LI-YING WANG HE, Tu-Cheng (TW)

(72) Inventor: LI-YING WANG HE, Tu-Cheng (TW)

(73) Assignee: HON HAI PRECISION INDUSTRY CO., LTD., Tu-Cheng (TW)

(21) Appl. No.: 13/402,964

(22) Filed: Feb. 23, 2012

(30) Foreign Application Priority Data
Nov. 21, 2011 (TW) 100142493

(51) Int. Cl. F26B 9/10

(52) U.S. Cl. 34/611

(57) ABSTRACT

A blow drying mechanism for drying plate-like members with pressurized air is disclosed. The blow drying mechanism includes an air inlet wall defining at least one inlet and an air outlet wall defining at least one outlet communicating with the at least one inlet. The at least one outlet is an elongated slot.

### BACKGROUND

1. Technical Field

The present disclosure relates generally to a blow drying tool, especially, to a blow drying mechanism for drying a plate-like workpiece.

2. Description of Related Art

During many manufacturing processes, products need to be cleaned one or more times. If the products are not dried effectively after cleaning, subsequent manufacturing steps may be affected negatively. Products not suitable to be dried by heating methods, the products may be blow dried. During drying, a nozzle connected to pressurized air directs airflow to surfaces of the products. However, the pressurized air may not strike all parts of a surface at the same pressure and may leave watermarks on surfaces of the products, which may in turn affects appearances and performances of the product negatively.

Therefore, there is room for improvement within the art.

### BRIEF DESCRIPTION OF THE DRAWINGS

The elements in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of a first embodiment of a blow drying mechanism.

FIG. 2 is similar to FIG. 1, but viewed from another aspect.

FIG. 3 is a cross-sectional view of the blow drying mechanism of FIG. 1, taken along line III-III.

FIG. 4 is another cross-sectional view of the blow drying mechanism of FIG. 1, taken along line IV-IV.

FIG. 5 is a cross-sectional view of a second embodiment of a blow drying mechanism.

### DETAILED DESCRIPTION

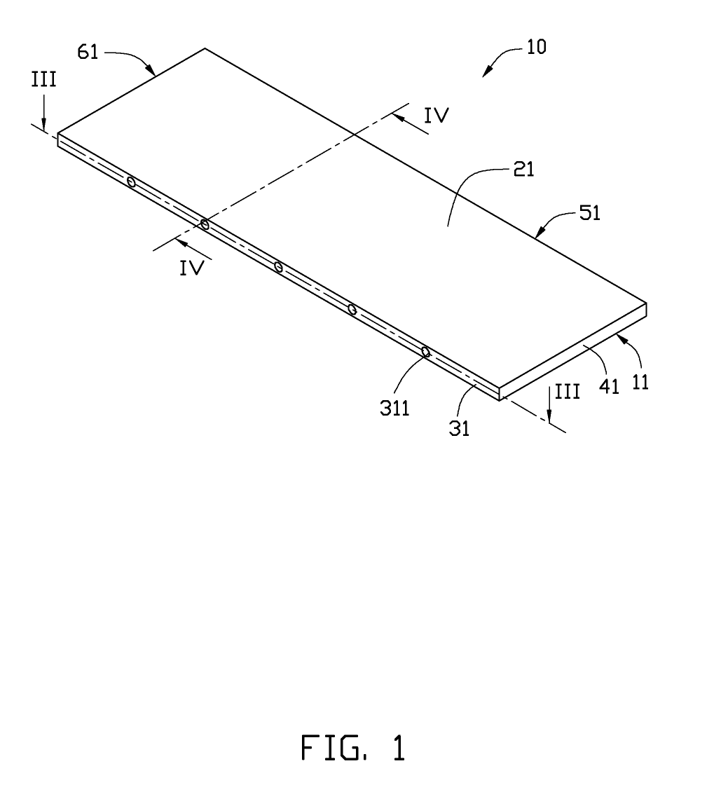

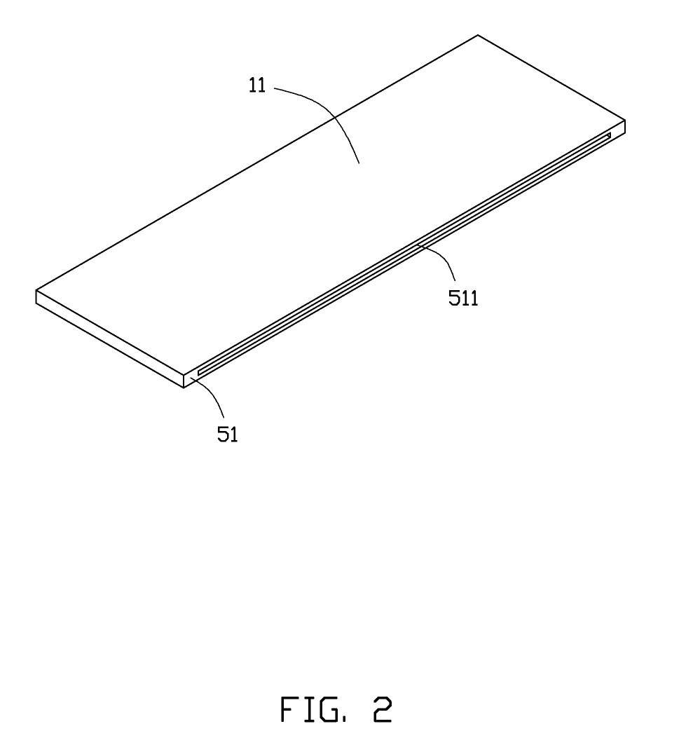

Referring to FIGS. 1 and 2, a first embodiment of a blow drying mechanism 10 is communicated with a pressurized air source (not shown), such that the blow drying mechanism 10 is used to dry a plate-like member (not shown) with the pressurized air. The blow drying mechanism 10 has a substantially rectangular, plate-like structure, and includes a bottom wall 11, a top wall 21 opposite to the bottom wall 11, an air inlet wall 31, a first sidewall 41, an air outlet wall 51 opposite to the air inlet wall 31, and a second sidewall 61 opposite to the first sidewall 41. The air inlet wall 31, the first sidewall 41, the air outlet wall 51, and the second sidewall 61 extend perpendicularly from a periphery of the bottom wall 11 to the top wall 21, and connect with each other in that order.

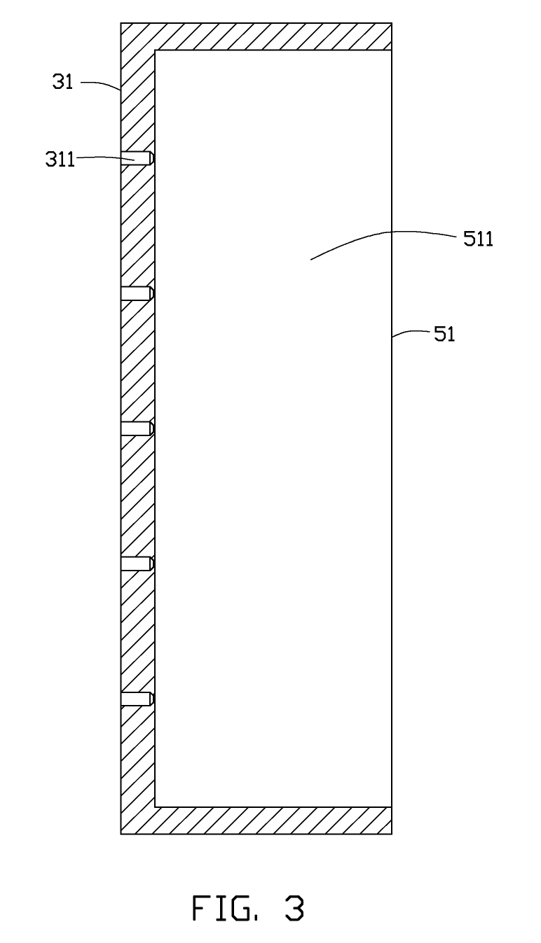

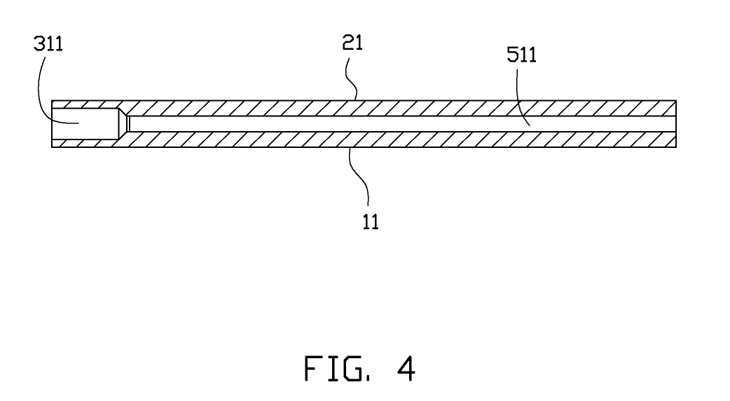

Also referring to FIGS. 3 and 4, a plurality of inlets 311 are defined in the air inlet wall 31. The plurality of inlets 311 are evenly spaced between each other. An extending direction of each of the plurality of inlets 311 is perpendicular to the air outlet wall 51. The plurality of inlets 311 are connected to an air outlet of the pressurized air source. In the first embodiment, the plurality of inlets 311 comprise five inlets. A cross section of each of the plurality of inlets 311 taken perpendicular to the extending direction of the plurality of inlets 311 is substantially circular. In alternative embodiments, the number of the plurality of inlets 311 can be changed according to need such as to accommodate work pieces of different size and shape.

An outlet 511 is defined in the air outlet wall 51, and is communicated with all of the plurality of inlets 311. The outlet 511 is an elongated slot, and extends from one end of the air outlet wall 51 to the other end of the air outlet wall 51. A length of the outlet 511 is greater than the sum of diameters of the plurality of inlets 311. In the first embodiment, the outlet 511 is substantially a rectangular slot. A width of the outlet 511 along a direction perpendicular to the bottom wall 11 is less than diameter of each of the plurality of inlets 311, to maintain a desired air pressure.

In alternative embodiments, the inlet 311 can be defined in the bottom wall 11, the top wall 21, the first sidewall 41, or the second sidewall 61.

When blow drying a plate-like member with the blow drying mechanism 10, the plate-like member is placed opposite to the outlet 511, and a predetermined angle is formed between the plate-like member and the air outlet wall 51, such as 30 degrees or 60 degrees. Because the outlet 511 is an elongated slot, the pressurized air strikes linearly to the plate-like member, and diffuses along a surface of the plate-like member at the same pressure. Thus, the surface of the plate-like member can be dried completely and effectively without leaving watermarks. The blow drying mechanism 10 has a simple structure with a low cost.

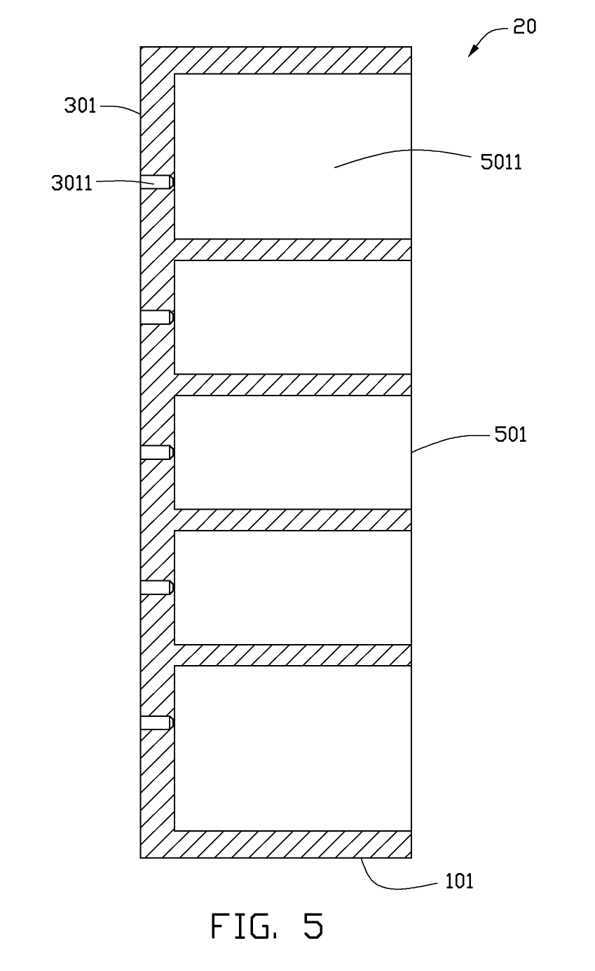

Referring to FIG. 5, a second embodiment of a blow drying mechanism 20 has a similar structure to the first embodiment of the blow drying mechanism 10. However, a plurality of outlets 5011 are defined in an air outlet wall 501, a number of the plurality of outlets 5011 is the same as that of inlets 3011 defined in an air inlet wall 301, and each of the plurality of outlets 5011 is communicated with each of the inlets 3011. A length of each of the plurality of outlets 5011 is greater than diameter of each of the inlets 3011. A width of each of the plurality of outlets 5011 along a direction perpendicular to a bottom wall 101 is less than diameter of each of the inlets 3011. Because each of the plurality of outlets 5011 corresponds to one of the inlets 3011, when drying the plate-like member, a desired air pressure is easy to maintain, and the plate-like member can be dried effectively.

It is to be understood, however, that even through numerous characteristics and advantages of the disclosure have been set forth in the foregoing description, together with details of the structure and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A blow drying mechanism for drying plate-like members with pressurized air, comprising:
an air inlet wall defining at least one inlet; and
an air outlet wall defining an least one outlet communicating with the at least one inlet, wherein the at least one outlet is an elongated slot.

2. The blow drying mechanism of claim 1, further comprising two sidewalls, wherein each of the two sidewalls connects the air inlet wall and the air outlet wall, and each of the air inlet wall and the air outlet wall is on each side of each of the two sidewalls.

3. The blow drying mechanism of claim 1, wherein the blow drying mechanism is substantially plate-like.

4. The blow drying mechanism of claim 3, wherein the blow drying mechanism comprises a bottom wall connecting the air inlet wall and the air outlet wall, and each of the air inlet wall and the air outlet wall is on a side of the bottom wall opposite to each other.

5. The blow drying mechanism of claim 4, wherein a width of the at least one outlet along a direction perpendicular to the bottom wall is less than a width of the at least one inlet along the direction perpendicular to the bottom wall.

6. The blow drying mechanism of claim 4, wherein the at least one inlet comprises at least two inlets.

7. The blow drying mechanism of claim 6, wherein a length of the at least one outlet is greater than a total length of the at least two inlets.

8. The blow drying mechanism of claim 6, wherein the at least two inlets are evenly spaced between each other.

9. The blow drying mechanism of claim 1, wherein a quantity of the at least one inlet is same as a quantity of the at least one outlet.

10. The blow drying mechanism of claim 1, wherein the at least one outlet is substantially a rectangular slot.

11. The blow drying mechanism of claim 1, wherein the at least one outlet extends from one end of the air outlet wall to another end of the air outlet wall.

12. A blow drying mechanism for drying plate-like members with pressurized air, comprising:
an air inlet wall defining at least one inlet;
an air outlet wall defining an at least one outlet communicating with the at least one inlet, and the at least one outlet is an elongated slot extending from one end of the air outlet wall to another end of the air outlet wall; and
two sidewalls, wherein each of the two sidewalls connects the air inlet wall and the air outlet wall, and each of the air inlet wall and the air outlet wall is on each side of each of the two sidewalls.

13. The blow drying mechanism of claim 12, wherein the blow drying mechanism is substantially plate-like.

14. The blow drying mechanism of claim 13, wherein the blow drying mechanism further comprises a bottom wall; the air inlet wall, the air outlet wall, and each of the two sidewalls extend from a periphery of the bottom wall, and each of the air inlet wall and the air outlet wall is on each side of the bottom wall.

15. The blow drying mechanism of claim 14, wherein a width of the at least one outlet along a direction perpendicular to the bottom wall is less than a width of the at least one inlet along the direction perpendicular to the bottom wall.

16. The blow drying mechanism of claim 14, wherein the at least one inlet comprises at least two inlets.

17. The blow drying mechanism of claim 16, wherein a length of the at least one outlet is greater than a total length of the at least two inlets.

18. The blow drying mechanism of claim 17, wherein the at least two inlets are evenly spaced between each other.

19. The blow drying mechanism of claim 12, wherein a quantity of the at least one inlet is same as a quantity of the at least one outlet.
